(19) United States
(12) Patent Application Publication
(10) Pub. No.: US 2008/0183738 A1
(43) Pub. Date: Jul. 31, 2008

(54) APPARATUS AND METHOD FOR COMPRESSING DATA

(75) Inventors: Chung-Li SHEN, Taipei City (TW); Hung-Lin KUAN, Taipei City (TW); Yu-Chieh CHUNG, Taipei City (TW)

Correspondence Address: J C PATENTS, INC., 4 VENTURE, SUITE 250, IRVINE, CA, 92618, US

(73) Assignee: BEYOND INNOVATION TECHNOLOGY CO., LTD., Taipei City (TW)

(21) Appl. No.: 11/862,776

(22) Filed: Sep. 27, 2007

(30) Foreign Application Priority Data
Jan. 30, 2007 (TW) 96103372

(51) Int. Cl. G06F 17/30

(52) U.S. Cl. 707/101; 707/E17.005

(57) ABSTRACT

A data compression apparatus and a method thereof are provided. In the present invention, a processing unit is used for sequentially transforming a plurality of spatial domain data of a macro block into a plurality of coefficient data according to a coding sequence. Then, an entropy coder is used for sequentially coding the coefficient data according to the same coding sequence. Thereby, the processing unit and the entropy coder operate in parallel so that the operation waiting time is reduced and accordingly the operation speed is increased.

### CROSS-REFERENCE TO RELATED APPLICATION

This application claims the priority benefit of Taiwan application serial no. 96103372, filed on Jan. 30, 2007. All disclosure of the Taiwan application is incorporated herein by reference.

### BACKGROUND OF THE INVENTION

1. Field of the Invention

The present invention generally relates to a data compression apparatus and a method thereof, and more particularly to a data compression apparatus having a pipeline architecture for processing data in parallel and a method thereof.

2. Description of Related Art

Many compression standards, such as H.261, H.263, MPEG-1, MPEG-2, and MPEG-4, have been provided along with the advancement of digital signal processing, storage media, and transmission method. H.264/AVC is a new generation video compression standard provided by International Telecommunication Union-Telecommunication Standardization Sector (ITU-T) and which can be broadly applied to coding and decoding of video data, such as video conference, video broadcasting, or video streaming service etc.

According to H.264 coding standard, a data is coded in blocks, namely, an image is first divided into a plurality of macro blocks (MB), and data coding is respectively performed on these macro blocks. While performing image coding according to H.264 coding standard, the image is coded in 16×16 macro blocks, and each of the 16×16 macro blocks is further divided into 4×4 macro blocks to be subsequently processed (i.e., a 16×16 macro block includes 16 4×4 macro blocks).

FIG. 1 is a flowchart of a conventional data compression method. Referring to FIG. 1, first, in step S110, redundant data in an input macro block is removed through data transformation and quantization. In other words, space redundancy in a residual image obtained by eliminating image similarities is removed through block transformation, and then the information quantity in the residual image is reduced through data quantization so as to obtain the coefficient data of the macro block.

Next, in step S120, the coefficient data is converted from a two-dimensional coefficient data into a one-dimensional coefficient data through specific scanning algorithm, such as zig-zag scanning algorithm or field scanning algorithm. Finally, in step S130, the one-dimensional coefficient data obtained in step S120 is inversely transformed and then entropy coding is performed thereon to obtain a bit stream data.

FIG. 2 is a diagram of scanning sequences of a conventional 4×4 macro block, and FIG. 3 illustrates the one-dimensional arrays of the scanning sequences of the conventional 4×4 macro block. Referring to FIG. 2 and FIG. 3, wherein FIG. 2(a) illustrates a zig-zag scanning sequence, FIG. 2(b) illustrates a field scanning sequence, FIG. 3(a) illustrates a one-dimensional array 0˜15 obtained by scanning the 4×4 macro block, and FIG. 3(b) illustrates the result obtained by inversely transforming the one-dimensional array in FIG. 3(a). As shown in FIG. 2, the 4×4 macro block is scanned from number 0 to number 15 sequentially following the arrows so as to obtain the one-dimensional array 0˜15 as shown in FIG. 3(a). In step S130, the entropy coding is performed starting from number 15 backward, thus, the original one-dimensional array 0˜15 is inversely transformed into a one-dimensional array 15˜0, as shown in FIG. 3(b).

As described above, the entropy coding process in step S130 is started when all the 16 coefficient data in the 4×4 macro block has been obtained. FIG. 4 is a timing diagram of a conventional data compression procedure. Referring to FIG. 4, if it is assumed that the process 410 for obtaining the coefficient data requires 16 clock cycles and the process 420 for performing entropy coding requires 17 clock cycles, then the conventional data compression procedure requires 33 clock cycles in total. Thereby, how to reduce the time of data compression has become a major subject in today's research and development of data compression technique.

### SUMMARY OF THE INVENTION

Accordingly, the present invention is directed to a data compression apparatus, wherein a processing unit and an entropy coder having a pipeline architecture are used for performing entropy coding so that the processing unit and the entropy coder can operate in parallel and accordingly the operation waiting time can be reduced.

The present invention is directed to a data compression method, wherein data quantization is performed sequentially according to a coding sequence to obtain a plurality of coefficient data, and once a coefficient data is obtained, an entropy coding is performed right away on this coefficient data according to the same coding sequence, so that the operation speed can be increased.

The present invention provides a data compression apparatus including a processing unit and an entropy coder. The processing unit transforms a plurality of first spatial domain data of a macro block into a plurality of coefficient data according to a coding sequence. The entropy coder performs entropy coding on the coefficient data according to the coding sequence.

According to an embodiment of the present invention, the processing unit includes a subtractor, a block transformer, a quantizer, an output buffer, an inverse quantizer, an inverse block transformer, an adder, and a register. The block transformer receives a macro block through the subtractor and transforms the first spatial domain data of the macro block into a plurality of first frequency domain data. The quantizer quantizes the first frequency domain data into the coefficient data according to the coding sequence and outputs the coefficient data to the output buffer. The inverse quantizer inversely quantizes the coefficient data into a plurality of second frequency domain data. The inverse block transformer inversely transforms the second frequency domain data into a plurality of second spatial domain data. The adder is coupled between the register and the inverse block transformer for restoring the second spatial domain data and outputting the restored second spatial domain data to the subtractor.

According to an embodiment of the present invention, when the processing unit is transforming the coefficient data, the entropy coder performs entropy coding on one of the transformed coefficient data according to the coding sequence.

According to an embodiment of the present invention, the processing unit and the entropy coder have a pipeline architecture.

The present invention provides a data compression method. According to this method, first, a plurality of first spatial domain data of a macro block is transformed into a plurality of coefficient data according to a coding sequence, and then an entropy coding is performed on the coefficient data according to the same coding sequence.

According to an embodiment of the present invention, the step of transforming the first spatial domain data of the macro block into the coefficient data according to the coding sequence further includes following steps. First, the first spatial domain data is transformed into a plurality of first frequency domain data, and then the first frequency domain data is quantized into the coefficient data according to the coding sequence.

According to an embodiment of the present invention, the coefficient data is further inversely quantized into a plurality of second frequency domain data, and the second frequency domain data is then inversely transformed into a plurality of second spatial domain data. Finally, the second spatial domain data is restored.

According to an embodiment of the present invention, an entropy coding is performed on one of the transformed coefficient data according to the coding sequence while transforming the coefficient data.

According to an embodiment of the present invention, the coding sequence includes zig-zag scanning reverse sequence or field scanning reverse sequence. The entropy coding includes context adaptive variable length coding (CAVLC) and context adaptive binary arithmetic coding (CABAC).

In the present invention, the processing unit and the entropy coder having a pipeline architecture, wherein the processing unit sequentially performs data quantization according to a coding sequence to obtain a plurality of coefficient data, and once a coefficient data is obtained, the entropy coder performs an entropy coding on the coefficient data according to the same coding sequence. Thereby, the processing unit and the entropy coder operate in parallel so that the operation waiting time is reduced and accordingly the operation speed is increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a conventional data compression method.

FIG. 2 is a diagram of scanning sequences of a conventional 4×4 macro block.

FIG. 3 illustrates the one-dimensional arrays of scanning sequences of a conventional 4×4 macro block.

FIG. 4 is a timing diagram of a conventional data compression procedure.

FIG. 5 is a block diagram of a data compression apparatus according to an embodiment of the present invention.

FIG. 6 is a block diagram of a data compression apparatus according to an embodiment of the present invention.

FIG. 7 is a flowchart of a data compression method according to an embodiment of the present invention.

FIG. 8 is a diagram of coding sequences according to an embodiment of the present invention.

FIG. 9 illustrates a pipeline processing of data transformation and entropy coding according to an embodiment of the present invention.

FIG. 10 is a timing diagram of a data compression procedure according to an embodiment of the present invention.

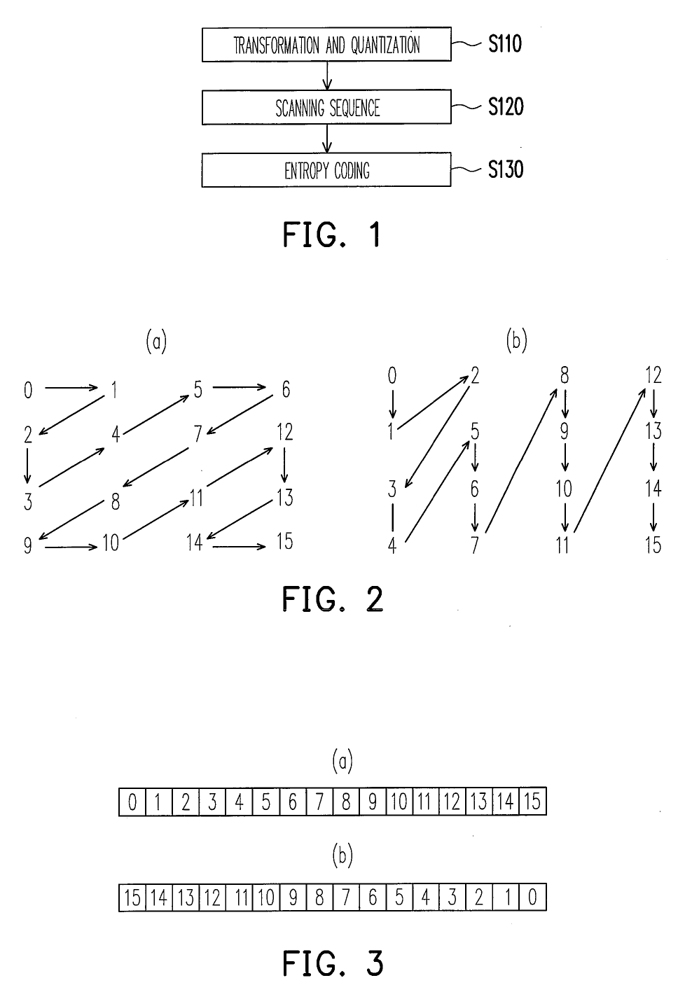

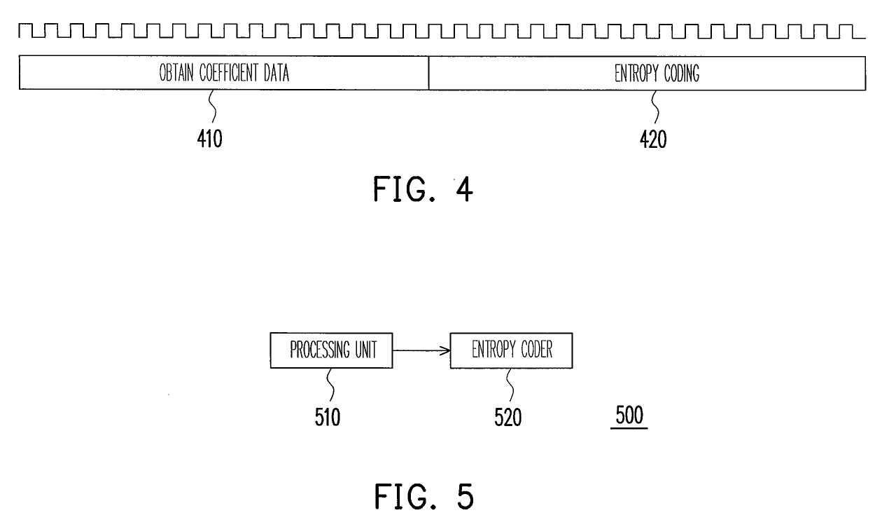

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 5 is a block diagram of a data compression apparatus according to an embodiment of the present invention. Referring to FIG. 5, the data compression apparatus 500 is used for compressing and encoding an input image and which includes a processing unit 510 and an entropy coder 520.

The processing unit 510 transforms the spatial domain data of a macro block into coefficient data according to a coding sequence. The method of the processing unit 510 transforming the macro block may include discrete cosine transformation (DCT) and quantization. The coding sequence may be zig-zag scanning reverse sequence or field scanning reverse sequence.

To be specific, the input image is divided into a plurality of rectangular zones referred as macro blocks (MBs). The processing unit 510 eliminates the similarities among images from the input image to obtain a residual image, and then the processing unit 510 performs DCT and quantization on the residual image to remove the redundant data and obtain the coefficient data.

The processing unit 510 operates according to the same coding sequence as the entropy coder 520. The entropy coder 520 performs entropy coding on the coefficient data output by the processing unit 510. Since the coding sequence of the processing unit 510 is the same as that of the entropy coder 520, the entropy coder 520 can immediately perform entropy coding on the coefficient data which has been processed by the processing unit 510.

For example, when the processing unit 510 is processing a plurality of data according to the coding sequence of the entropy coder 520, the processing unit 510 sequentially encodes the data and sequentially output the coefficient data. At the same time, the entropy coder 520 can perform entropy coding on the coefficient data output by the processing unit 510. The entropy coder 520 does not have to wait for the processing unit 510 to output all the coefficient data before it starts to perform entropy coding on the coefficient data. Thereby, during data processing of the processing unit 510 and the entropy coder 520 in the data compression apparatus 500, the time of the entropy coder 520 waiting for the processing unit 510 to output data is saved.

In the present embodiment, the processing unit 510 and the entropy coder 520 have a pipeline architecture such that a series of instructions can be processed in parallel and accordingly the data operation speed of the entropy coder 520 can be increased.

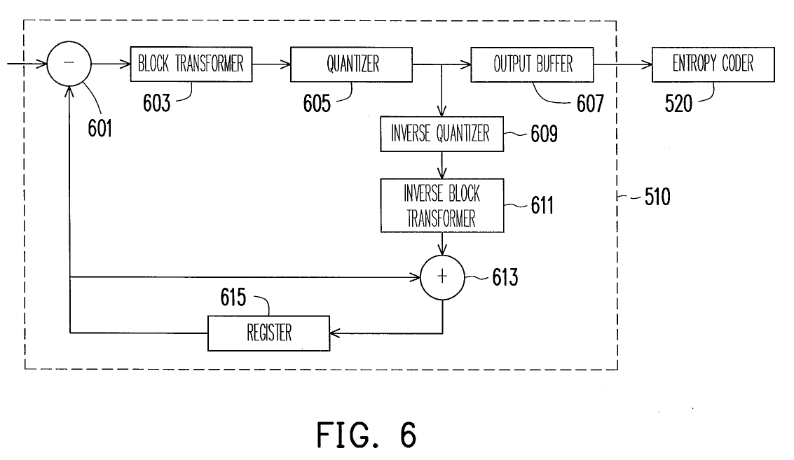

Below, a data compression apparatus provided by the present invention will be described in detail with reference to an embodiment of the present invention. FIG. 6 is a block diagram of a data compression apparatus according to an embodiment of the present invention. Referring to FIG. 6, in the present embodiment, the processing unit 510 includes a subtractor 601, a block transformer 603, a quantizer 605, an inverse quantizer 609, an inverse block transformer 611, an adder 613, and a register 615. The processing unit 510 compresses an input image through a series of calculations and transformations to obtain a plurality of coefficient data.

The block transformer 603 receives a macro block through the subtractor 601 and transforms the spatial domain data of the macro block into a plurality of frequency domain data. Because human eyes are not sensitive to the high-frequency part of an image, the quality of the image will not be affected even the high-frequency part thereof is removed, but the compression ratio of the image can be increased by removing the high-frequency part thereof.

The quantizer 605 quantizes the frequency domain data into the coefficient data according to the coding sequence of the entropy coder 520 and outputs the coefficient data to the output buffer 607. In other words, the quantizer 605 is used for reducing the value of the frequency domain data transformed by the block transformer 603 to obtain a better compression ratio.

However, according to the present invention, the data may also be processed by the block transformer 603 according to the coding sequence of the entropy coder 520 so that the sequence in which the processing unit 510 outputs the coefficient data matches the coding sequence of the entropy coder 520.

In the present embodiment, the processing unit 510 further includes an output buffer 607 for registering the quantized coefficient data. When the quantizer 605 outputs a coefficient data, the coefficient data is then handed over to the entropy coder 520 to be processed. Thus, before the entropy coder 520 finishes processing the previous coefficient data, the next coefficient data output by the quantizer 605 is registered in the output buffer 607. The volume of the output buffer 607 is smaller than the number of the coefficient data and which can be determined according to the number of pipelines and the operation speed of the entropy coder 520 but is not limited herein.

The inverse quantizer 609 and the inverse block transformer 611 are used for predicting internal encoding blocks. The inverse quantizer 609 inversely quantizes the coefficient data obtained by the quantizer 605 into a plurality of frequency domain data, and the inverse block transformer 611 inversely transforms the frequency domain data obtained by the inverse quantizer 609 into a plurality of spatial domain data.

The adder 613 coupled between the register 615 and the inverse block transformer 611 restores the spatial domain data obtained by the inverse block transformer 611 and outputs the restored spatial domain data to the subtractor 601 to obtain a residual image. In other words, the inverse quantizer 609 and the inverse block transformer 611 inversely quantize and inversely transform the quantized coefficient data, and the result obtained is added to a previous prediction image (registered in the register 615) by the adder 613 to obtain a re-built image. The re-built image is registered in the register 615 and is used as a reference image for motion estimation and motion compensation of the next image.

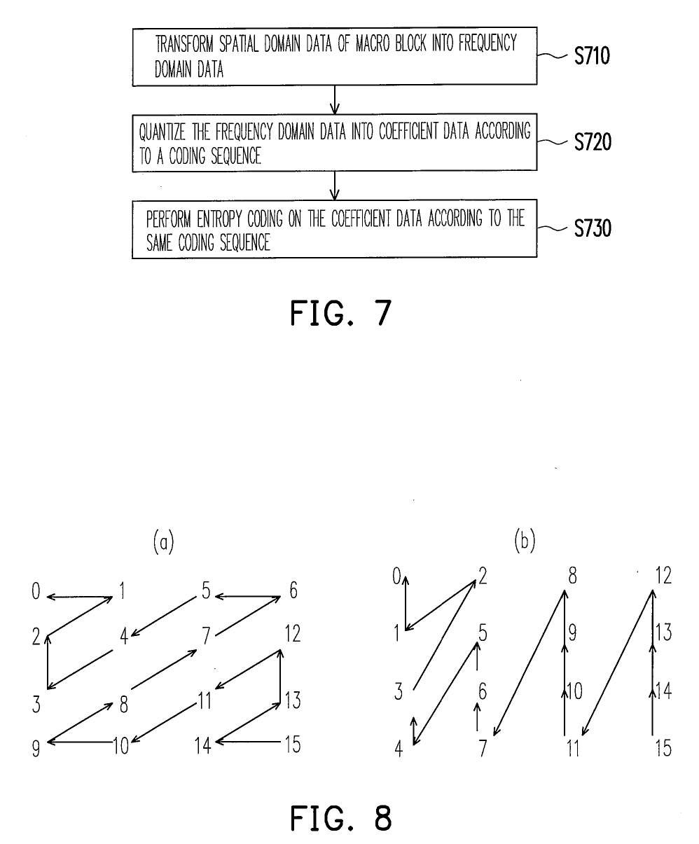

To explain foregoing concept more clearly, a data compression method provided by the present invention will be described in detail with reference to the data compression apparatus in foregoing embodiment. FIG. 7 is a flowchart of a data compression method according to an embodiment of the present invention. Referring to FIG. 6 and FIG. 7, in the data compression method, a macro block is first processed by the block transformer 603 to obtain a plurality of frequency domain data, and the frequency domain data is then quantized by the quantizer 605, and finally, the quantized data is processed and output by the entropy coder 520.

First, in step S710, the spatial domain data of the macro block is transformed into the frequency domain data by the block transformer 603. For example, the block transformer 603 removes redundant data in the spatial domain through DCT.

Next, in step S720, the quantizer 605 quantizes the frequency domain data into a plurality of coefficient data according to a coding sequence of the entropy encoder 520. For example, the quantizer 605 obtains a plurality of interval indexes from a quantization table as the coefficient data so that the coefficient data contains all integers.

In step S720, because the macro block is a two-dimensional array, the two-dimensional array has to be converted into a one-dimensional array before entropy coding is performed. The two-dimensional array may be converted into the one-dimensional array through zig-zag scanning algorithm or field scanning algorithm.

FIG. 8 is a diagram of coding sequences according to an embodiment of the present invention. Referring to FIG. 6, FIG. 7, and FIG. 8, FIG. 8(a) illustrates a zig-zag scanning reverse sequence, and FIG. 8(b) illustrates a field scanning reverse sequence. In step S720, the data is sequentially quantized along the arrow direction starting from number 15 as illustrated in FIG. 8(a) or FIG. 8(b).

Additionally, to obtain a reference image for the motion estimation and motion compensation of a next image, the coefficient data obtained in step S720 is inversely quantized into a plurality of frequency domain data by the inverse quantizer 609, and the frequency domain data is then reversely transformed into a plurality of spatial domain data by the inverse block transformer 611, so as to restore the macro block.

Finally, in step S730, the entropy coder 520 sequentially performs entropy coding on the coefficient data obtained by the processing unit 510 according to the same sequence in which the processing unit 510 transforms the spatial domain data of the macro block into the coefficient data. In other words, while the processing unit 510 is transforming the data, the entropy coder 520 performs entropy coding on the transformed coefficient data according to the same sequence. The entropy coding may be context adaptive variable length coding (CAVLC) or context adaptive binary arithmetic coding (CABAC).

Taking a 4×4 macro block, which is numbered as illustrated in FIG. 8, as example, first, the quantizer 605 quantizes the frequency domain data 15, and after obtaining the coefficient data 15, the quantizer 605 sends the coefficient data 15 to the entropy coder 520. While the entropy coder 520 is performing entropy coding on the coefficient data 15, the quantizer 605 quantizes the frequency domain data 14 to obtain a coefficient data 14, and so on.

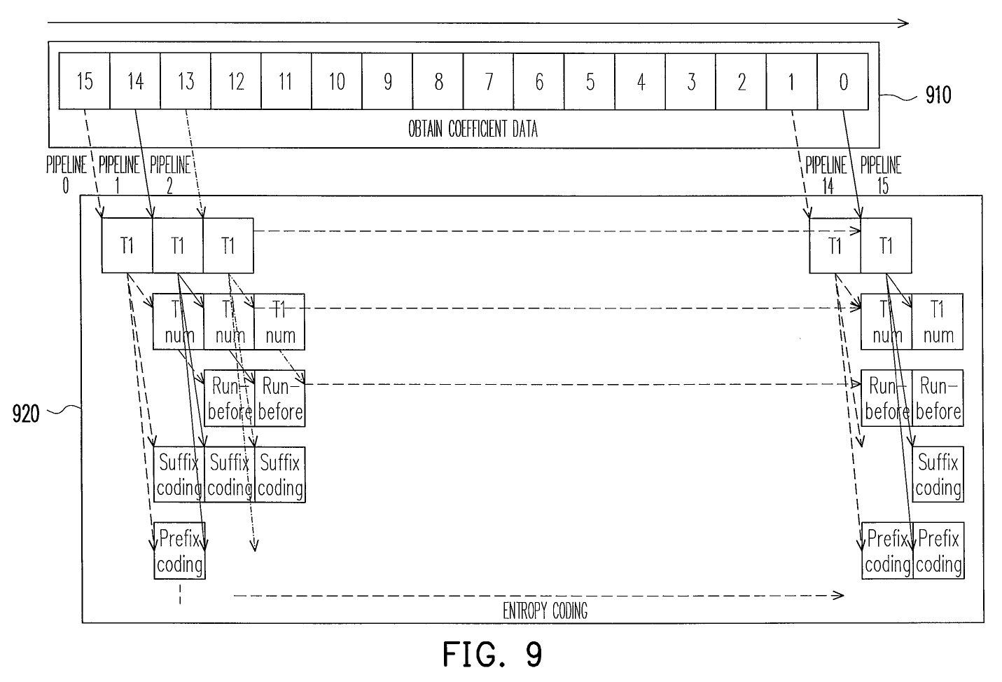

To explain foregoing concept more clearly, another embodiment of the present invention will be further described. For example, according to the baseline profile provided by H.264 coding standard, the macro blocks of a residual image are coded through CAVLC, and the other information of the residual image are coded through a variable length coding with regular construction (Exp-Golomb). FIG. 9 illustrates a pipeline processing of data transformation and entropy coding according to an embodiment of the present invention. Referring to FIG. 9, in the present embodiment, 16 pipelines (i.e. pipelines 0˜15) are adopted so that the process 910 for obtaining the coefficient data and the process 920 of entropy coding can be carried out in parallel.

In the process 910 for obtaining the coefficient data, the 4×4 macro block is sequentially quantized according to a reversed scanning sequence (i.e. the coding sequence, as shown in FIG. 8), and the coefficient data is scanned from low frequency to high frequency, wherein number 0˜15 is the original scanning sequence and number 15˜0 is the coding sequence. Thus, the entropy coding process 920 can be carried out once a coefficient data is obtained.

“T1”, “T1 num”, and “Run-before” are execution parameters of CAVLC, wherein “T1” represents a process for determining whether a coefficient data is 1 or −1, “T1 num” represents a process for detecting the number of the absolute value of the current coefficient data being 1, and “Run-before” represents the number of continuous coefficient data having value 0 before the current coefficient data. In addition, “Suffix coding” and “Prefix coding” are two essential processes of CAVLC and which are used for calculating the code lengths and values of those coefficients which are neither 0 nor 1.

When coefficient data 15 is obtained, process “T1” is performed on the coefficient data 15 through “pipeline 0”, and when process “T1” is being carried out on the coefficient data 15, the frequency domain data 14 can be quantized to obtain the coefficient data 14. When the process “T1” performed to the coefficient data is completed and process “T1 num” is started, process “T1” is performed on the coefficient data 14 through “pipeline 1”, and so on.

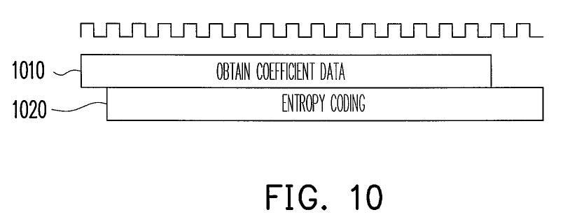

FIG. 10 is a timing diagram of a data compression procedure according to an embodiment of the present invention. Referring to FIG. 10, a pipeline architecture is adopted in the present embodiment, thus, the process of entropy coding 1020 can be carried out in parallel while the process 1010 for obtaining the coefficient data is in process. Accordingly, the data compression procedure is completed within only 18 clock cycles.

In overview, the data compression apparatus and the method thereof provided by the present invention have at least following advantages:

1. the quantized data is output according to an entropy coding sequence so that the waiting time of entropy coding is reduced.

2. various processes are carried out in parallel through a pipeline architecture so that the coding speed is increased.

3. since various processes are carried out in parallel through the pipeline architecture, the storage space of the output buffer is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data compression apparatus, comprising:
a processing unit, transforming a plurality of first spatial domain data of a macro block into a plurality of coefficient data; and
an entropy coder, performing entropy coding on the coefficient data;
wherein the processing unit sequentially provides the coefficient data to the entropy coder according to a coding sequence of the entropy coder.

2. The data compression apparatus according to claim 1, wherein the processing unit comprises:
a block transformer, receiving the macro block through a subtractor, and transforming the first spatial domain data into a plurality of first frequency domain data; and
a quantizer, quantizing the first frequency domain data into the coefficient data according to the coding sequence, and outputting the coefficient data.

3. The data compression apparatus according to claim 2, wherein the processing unit comprises:
an output buffer, receiving the coefficient data from the quantizer, wherein the entropy coder accesses the coefficient data in the output buffer to perform entropy coding on the coefficient data.

4. The data compression apparatus according to claim 2, wherein the processing unit further comprises:
an inverse quantizer, inversely quantizing the coefficient data into a plurality of second frequency domain data;
an inverse block transformer, inversely transforming the second frequency domain data into a plurality of second spatial domain data; and
an adder, coupled between a register and the inverse block transformer, for restoring the second spatial domain data and outputting the second spatial domain data to the subtractor and itself through the register.

5. The data compression apparatus according to claim 1, wherein when the processing unit is transforming the coefficient data, the entropy coder performs entropy coding on one of the coefficient data which has been transformed by the processing unit according to the coding sequence.

6. The data compression apparatus according to claim 1, wherein the processing unit and the entropy coder have a pipeline architecture.

7. The data compression apparatus according to claim 1, wherein the coding sequence comprises zig-zag scanning reverse sequence or field scanning reverse sequence.

8. The data compression apparatus according to claim 1, wherein the method of the processing unit transforming the macro block comprises discrete cosine transforming (DCT) and quantization.

9. A data compression method, comprising:
providing a plurality of coefficient data sequentially according to a coding sequence of an entropy coder; and
performing entropy coding on the coefficient data.

10. The data compression method according to claim 9 further comprising:
transforming a plurality of first spatial domain data of a macro block into the coefficient data according to the coding sequence and sequentially providing the coefficient data according to the coding sequence.

11. The data compression method according to claim 10, wherein the step of transforming the first spatial domain data of the macro block into the coefficient data according to the coding sequence comprises:
transforming the first spatial domain data into a plurality of first frequency domain data; and
quantizing the first frequency domain data into the coefficient data according to the coding sequence.

12. The data compression method according to claim 9 further comprising:
inversely quantizing the coefficient data into a plurality of second frequency domain data;
inversely transforming the second frequency domain data into a plurality of second spatial domain data; and
restoring the second spatial domain data.

13. The data compression method according to claim 9, wherein while transforming the coefficient data, an entropy coding is performed on one of the transformed coefficient data according to the coding sequence.

14. The data compression method according to claim 9, wherein the method for transforming the macro block comprises DCT and quantization.

15. The data compression method according to claim 9, wherein the coding sequence comprises zig-zag scanning reverse sequence or field scanning reverse sequence.

16. The data compression method according to claim 9, wherein the entropy coding comprises context adaptive variable length coding (CAVLC) and context adaptive binary arithmetic coding (CABAC).
